(19) United States
(12) Patent Application Publication
(10) Pub. No.: US 2012/0309249 A1
(43) Pub. Date: Dec. 6, 2012

(54) MULTI-LAYER FABRIC AND PROCESS FOR MAKING THE SAME

(76) Inventors: Stephen John Von Bokern, Greer, SC (US); Juergen Friedrich Rudolph, Peine (DE); Daniel Alexander Dayan, Wimbledon (GB)

(21) Appl. No.: 13/444,288

(22) Filed: Apr. 11, 2012

Related U.S. Application Data
(60) Provisional application No. 61/474,133, filed on Apr. 11, 2011.

(30) Foreign Application Priority Data
Aug. 24, 2011 (EP) 11178650.5

(51) Int. Cl. D04H 1/00; B32B 37/14; B05D 7/00; B32B 5/22; A41B 9/00

(52) U.S. Cl. 442/329; 2/400; 427/180; 156/229

(57) ABSTRACT

The invention provides a multi-layer fabric which is comprised of a first layer and a second layer which are adhered to each other, wherein the first layer comprises an elastic fabric of fibers of a polyolefin material which elastic fabric has an ultimate elongation of at least 500%; and wherein the second layer comprises a bonded nonwoven fabric of polyolefin staple fibers in which fiber-to-fiber bonds are present, which nonwoven fabric has an elongation in the cross machine direction of at least 130%, and wherein the polyolefin staple fibers have an elongation of at least 350%. The invention further provides processes for making the multi-layer fabric, an article or article component comprising the multi-layer component, and the use of the multi-layer fabric in diaper or training pant applications.

### FIELD OF THE INVENTION

The present invention relates to a multi-layer fabric, a process for making the fabric, an article or article component comprising the fabric, and the use in absorption applications such as the use in diapers.

### BACKGROUND OF THE INVENTION

There is an increasing demand for highly elastic and breathable nonwoven fabrics having desirable strength, conformability, and extensibility properties, suitable for use in absorbent articles, such as disposable diapers, adult incontinence pads and sanitary napkins, and the like. In such articles it is important to have a soft outer fabric for contact with the skin of the user in combination with a durable and strong fabric having sufficient fluid absorption capacity.

Typically such nonwoven fabrics are multi-layer fabrics which comprise a layer of a highly elastic film to provide elasticity and a nonwoven fabric to provide the desired soft and cushion-like texture.

Such nonwoven fabrics have for instance been described in US 2010/0081352 A1. In said document, nonwoven fabrics have been disclosed having one or more layers of propylene-ethylene copolymer to which is adhered an extensible nonwoven spunlace fabric.

There still exist room for improvement, however, in terms of softness of the fabric when applied to a body and production costs. Object of the present invention is to provide multi-layer nonwoven fabrics that display an improved softness and which are economically attractive to make.

### SUMMARY OF THE INVENTION

It has now been found that this can be realised when use is made of a multi-layer fabric which is comprised of an elastic fabric of fibers of a polyolefin material having a high ultimate elongation in combination with a particular nonwoven fabric, which fabrics are adhered to each other.

Accordingly, the present invention relates to a multi-layer fabric comprised of a first layer and a second layer which are adhered to each other, wherein the first layer comprises an elastic fabric of fibers of a polyolefin material which elastic fabric has an ultimate elongation of at least 500%; and wherein the second layer comprises a bonded nonwoven fabric of polyolefin staple fibers in which fiber-to-fiber bonds are present, which nonwoven fabric has an elongation in the cross machine direction of at least 130%, and wherein the polyolefin staple fibers have an elongation of at least 350%.

The multi-layer fabrics which are made of the first and second layers in accordance with the present invention can be processed into fabrics displaying a unique softness, whereas they are highly attractive from a production cost perspective.

### DETAILED DESCRIPTION OF THE INVENTION

The first layer to be used in making the multi-layer fabric in accordance with the present invention comprises an elastic fabric of fibers of a polyolefin material, the elastic fabric having an ultimate elongation of at least 500%, preferably at least 600%.

The term “elastic” is used as meaning stretchable under force and recoverable to its original or essentially original form upon release of that force.

In the context of the present invention the ultimate elongation is defined as the elongation at which rupture occurs in the application of continued tensile stress. In accordance with the present invention the ultimate elongation of the elastic fabric is determined by ASTM test method 5035-95 modified to use 1 inch×8 inch strip; 5 inch gage length and 5 inch/minute pull rate.

A wide range of suitable polyolefin materials can be used in the present invention. Suitable examples include polyethylene, polypropylene, polybutadiene, poly(ethylenebutene), poly(ethylene-hexene), poly(ethylene-octene), poly(ethylene-propylene) block polymers such as styrene/isoprene/styrene and styrene/polybutadiene/styrene. The polyolefin material may comprise a homopolymer or a copolymer such as propylene-α-olefins copolymers. In particularly, the latter copolymers can attractively be used in the present invention. Preferred are polyolefin materials that comprise a propylene-α-olefin copolymer and a propoylene homopolymer.

Suitably, the homopolymers or copolymers of α-olefins to be used in the present invention have a crystallinity of less than 40%.

The melt flow rate (MFR) of the polyolefin material is suitably less than 90 dg/min. The MFR is determined using ASTM test method D1238, 2.16 kg, 230° C. Preferably, the MFR of the polyolefin material is in the range f from 15-50 dg/min, more preferably in the range of from 15-25 dg/min.

Preferably, the polyolefin material is a propylene-based or ethylene-based homopolymer or a copolymer. In the case of propylene-based polymers the polymers may comprise comonomer-derived units selected from ethylene and C₄-C₁₀ α-olefins. In the case of ethylene-based polymers the polymers may comprise comonomer-derived units selected from C₃-C₁₀ α-olefins. Suitable examples of polyolefin materials include propylene homopolymers, ethylene homopolymers, propylene copolymers and ethylene copolymers having a crystallinity of less than 40%, such as linear low density polyethylene (LLDPE), high density polyethylene (HDPE), and low density polyethylene (LDPE).

Attractive polyolefin materials to be used in the present invention include elastomeric polypropylene materials as disclosed in WO 2005/052052, US 2020/0081352 and WO 2005/097031 which documents are hereby incorporated by reference. In particular the polypropoylene materials as described in WO 2005/052052 can suitably be used in the present invention.

Hence, in a preferred embodiment of the present invention the polyolefin material comprises a first component comprising 5-99 wt %, based on the total weight of the polyolefin material, of a polymer selected from the group consisting of homopolymers of propylene and random copolymers of propylene, the polymer having a heat of fusion as determined by DSC of less than 50 J/g and stereoregular propylene crystallinity; and a second component which comprises 1-95 wt %, based on the total weight of the polyolefin material, of a propylene polymer or a blend of propylene polymers; wherein the first and/or the second component has undergone chain scission, and the elastic fabric has a permanent set of less than 60%.

Preferred polypropylene materials to be used are available from ExxonMobil under the tradename Vistamaxx®.

In accordance with the present invention the heat of fusion (Hf) is determined by means of the Differential Scanning calorimetry (DSC) procedure.

The elastomeric fabric to be used in the first layer comprises fibers of a polyolefin material. The fibers can suitably be meltblown fibers, meltspun fibers or melt spinning fibers. Preferably, the fibers are meltblown fibers or meltspun fibers. The average diameter of meltblown fibers is generally considered to be smaller than 15 μm, whereas the average diameter of spunbond fibers is typically in the range of from 15-60 μm or higher. Meltblown fibers are fibers derived from a meltblowing process which is as such known in the art.

A meltblowing process is a process in which fibers are formed by extruding a molten thermoplastic material through a plurality of fine, usually circular, die capillaries as molten threads or filaments into a high velocity, usually heated, gas streams which attenuate the filaments of molten thermoplastic material to reduce their diameter, which may be to microfiber diameter. The meltblown process normally has the filaments in single row of filaments across the width of the die. Thereafter, the meltblown fibers are carried by the high velocity gas stream and are deposited on a collecting surface to form a web of randomly dispersed meltblown fibers. Meltblown fibers are microfibers which may be continuous or discontinuous.

Spunbond fibers are fibers generally produced by the extrusion of molten polymer from either a large spinneret having several thousand holes per meter of width or with banks of smaller spinnerets, for example, containing as few as 40 holes. After exiting the spinneret, the molten fibers are quenched by a cross-flow air quench system, then pulled away from the spinneret and attenuated by high speed air. Spunbond fibers are generally continuous.

In making a multi-layer fabric according to the present invention, the polyolefin material may be meltblown or spunbond (generally referred to as meltspun) onto one or two nonwoven fabrics that are passed underneath or in front of the forming elastic spunmelt fabric. The melt temperature and distance between the spinnerets to the fabrics being used is adjusted such that the fibers are still in a partially molten state or partially amorphous state when contacting the fabric(s) to form a two or three layer fabric. The term “partially amorphous state” means that the fibers are in such a state that they provide sufficient adhesion between the first and second layers so as to ensure that the layers cannot easily be peeled apart by instance by a young child such as might be wearing a diaper.

The polyolefin material to be used in accordance with the present invention can suitably also comprises an additive. Such an additive can suitably selected from the group consisting of stabilizers, surfactants, antioxidants, fillers, colorants, whitening agents, nucleating agents, anti-block agents, UV-blockers/absorbers, UV-initiators, coagents, hydrocarbon resins, dispersing agents, catalyst deactivators, and slip additives. In the multi-layer fabric according to the present invention use is made of a bonded nonwoven fabric of polyolefin staple fibers in which fiber-to-fiber bonds are present, which nonwoven fabric has an elongation in the cross machine direction of at least 130%, and wherein the polyolefin staple fibers have an elongation of at least 350%.

The nonwoven fabric in the second layer to make the multi-layer fabric in accordance with the present invention is a bonded nonwoven fabric. The fiber-to-fiber bonds present in the nonwoven fabric can suitably be established using any known bonding techniques in the art. Suitably, bonding techniques include chemical bonding, thermal bonding, and mechanical bonding techniques. Preferably, the fiber-to-fiber bonds are formed by means of thermal bonding to provide a multiplicity of discrete thermal bonds throughout the nonwoven fabric.

Preferably, the nonwoven web is a carded nonwoven web.

Suitably, during web formation, the high elongation staple fibers are carded and oriented substantially in the cross machine direction of the web so that the web exhibits a tensile strength ratio in the machine direction as compared to the cross machine direction in the range of from 1-10, preferably 1-5, more preferably in the range of from 2-4. The use of high elongation fibers oriented in the cross machine direction as described above provides nonwoven fabrics having a high degree of cross machine direction elongation, yet also having good tensile strengths in the machine direction.

The amount of bond area is also believed to be a factor in providing the high cross machine direction elongation properties of the nonwoven fabrics. As the percent bond area decreases, as the skilled person will appreciate, the nonwoven fabric is typically insufficiently bond together, and can exhibit pilling, peeling, and the like. As the percentage bond area increases, desirable aesthetics of the fabrics decrease, i.e. the web may become stiff or boardy, and can exhibit decreased drapability. In addition, as bond area increases, the fabric is less able to expand without stressing or breaking bond sites, and accordingly desirable cross machine direction elongation is decreased.

Preferably, the fiber-to-fiber bonds have a bond area in the range of from 8-25%, based on the total area of the nonwoven fabric. Such a bond area also contributes to the high elongation properties of the nonwoven fabric. That is, the fabric is bond sufficiently to provide good strength properties but is not overly bond so as to avoid undesirable aesthetics, such as stiffness, and the like, or reduction in elongation properties. The design of the bond layout is constructed in such a way to promote cross web elongation maximization.

More preferably, the fiber-to-fiber bonds have a bond area in the range of from 8-20%, most preferably in the range of from 8-18%, based on total area of nonwoven fabric. In accordance with the present invention the bond area is determined using ASTM test method 5035-95 modified to use 1 inch×8 inch strip; 5 inch gage length and 5 inch/minute pull rate.

Carded nonwoven fabrics to be used in accordance with the present invention are formed using polyolefin staple fibers which have a high degree of elongation prior to processing. Typically, known staple fibers used in the nonwoven carded fabric production have a pre-processing elongation in the range of from 140-250%. In accordance with the present invention, however, the polyolefins staple fibers preferably used in the production of the high elongation fabrics have an elongation prior to processing in the range of from 350-600%. In addition, the polyolefin staple fibers used in accordance with the present invention have a sufficient tensile strength so as to provide good tensile properties of the final product. Accordingly, the polyolefin fibers used have a tenacity in the range of from 1.5-3 g/den, and preferably a tenacity in the range of from 1.8-2 g/den. Furthermore, the polyolefin staple fibers have preferably a denier in the range of from 1.8-3. High elongation fibers are known in the art and are commercially available, for example, from FiberVision, Inc. and Danaklon A/S. One exemplary example of fibers useful in the present invention is described in published European Patent Application 445,536-A2, the disclosure of which is incorporated herein in its entirety.

The thermal bonds act to bond the high elongation fibers of the web to form a strong nonwoven fabric having a high elongation. In accordance with the present invention the nonwoven fabric to be used has an elongation in the cross machine direction of at least 130%, preferably at least 150%, and more preferably at least 200%. Suitably, the nonwoven fabric has an elongation in the cross machine direction of at most 600%. The nonwoven fabric has preferably an elongation in the cross machine direction in the range of from 130-230%, preferably in the range of from 150-230%, more preferably in the range of from 170-230%. In contrast, known nonwoven carded thermobond fabrics typically exhibit cross machine direction elongation in the range of from 60100%.

In accordance with the present invention the elongation of the nonwoven fabrics in the cross machine direction is determined by means of ASTM test method 5035-95 modified to use 1 inch×8 inch strip; 5 inch gage length and 5 inch/minute pull rate.

The polyolefin staple fibers of the nonwoven fabric to be used in accordance with the present invention have an elongation of at least 350%, preferably at least 370%.

In the context of the present invention the elongation of the polyolefin staple fibers is defined as the elongation at peak tensile.

In accordance with the present invention the elongation of the polyolefin staple fibers is determined by means of FiberVisions internal test method.

The bond area is determined by means of a microscope.

The nonwoven fabrics to be used in accordance with the present invention suitably have a basis weight in the range of from 15-50 grams per square yard (gsm), a machine direction tensile strength in the range of from 1200-2900 grams/inch, and a cross machine direction tensile strength in the range of from 200-400 grams/inch.

Use of carded thermal bond technology to achieve high elongation and high tensile strength properties without sacrifice of aesthetics provides a significant advantage in the production of multi-layer nonwoven fabrics. Because the nonwoven fabrics to be used in accordance with the present invention exhibit good cross machine direction elongation properties, they can attractively be used as a component of multi-layer nonwoven products without requiring multiple processing and/or converting steps. Further, the nonwoven fabrics as applied in the present invention can be processed on existing fabric processing and converting equipment without requiring special devices. An advantage of the nonwoven fabrics used is that they can be manufactured more conveniently and efficiently and can be processed thereafter with less restrictions and lower cost than other nonwoven fabrics such as hydroentangled nonwoven fabrics.

According to the present invention the nonwoven fabric is preferably a carded nonwoven fabric. As is known in the art, carding is a mechanical process whereby clumps of staple fibers are separated into individual fibers and simultaneously made into a coherent web. Carding is typically carried out on a machine which utilizes opposed moving beds or surfaces of fine, angled closely spaced teeth or wires or their equivalent to pull and tease the clumps apart. The teeth of the two opposing surfaces typically are inclined in opposite directions and move at different speeds relative to each other. In traditional textile carding techniques, the two beds of teeth separate the clumps into individual fibers which are aligned predominantly and generally in the machine direction. The individualized fibers engage each other randomly, and with the help of their crimp, form a coherent web at and below the surface of the teeth on the main cylinder. The fibers are then directed to a moving screen via means for stripping or “doffing” the web off the cylinder.

In nonwoven carding processes, it is often desirable that the fibers be somewhat less oriented and that they be more randomly laid down to form the carded web. As will be appreciated by the skilled person, the carding machine can include additional rolls, referred to as “scrambler rolls,” and a mechanism connected therewith for adjusting the speed of the scrambler rolls relative to one another. Accordingly, the carding machine can be adjusted so that the scrambler rolls provide varying degrees of scramble ratios as compared to traditional textile carding apparatus.

The degree of scramble or transverse orientation of the fibers can be expressed as a ratio of tensile strength of the fabric in the machine direction (MD) as compared to the tensile strength in the cross machine direction (CD) of the carded web (expressed as MD/CD grams/inch). Typically, carded nonwoven webs exhibit a tensile strength ratio in the range of from 5-10. Preferably, the carded nonwoven fabric to be used in accordance with the present invention is formed so that the fibers are highly oriented in the cross machine direction, i.e. so that the number of fibers laid down transverse to the cross machine direction is controlled.

Preferably, the carded nonwoven fabrics have a tensile strength ratio (machine direction/cross machine direction) in the range of from 1-5, and preferably in the range of from 2-4, and more preferably in the range of from 2.5-3.5. Thus, a higher degree of the fibers are oriented substantially in the cross machine direction than in typical carded nonwoven fabrics to provide increased elongation in the cross machine direction.

Preferably, the draft used during the carding process is less than 50% total. The use of a relatively low draft helps in the transfer of the web from line to line and minimizes the loss of orientation in the cross machine direction.

Processes for making carded nonwoven fabric that can suitably be used in accordance with the present invention have been described for instance in U.S. Pat. No. 5,494,736 which is hereby incorporated by reference.

In the above-described embodiments the multi-layer fabric according to the invention comprises two layers. In another embodiment of the present invention the multi-layer fabric comprises in addition a third layer which comprises a nonwoven fabric of bond polyolefin staple fibers as defined hereinbefore, wherein the first layer is arranged between the second and the third layer.

The present invention provides a wide variety of multi-layer fabrics. Suitable multi-layer fabrics may include one or more layers of conventional (non-elastic) meltblown fabric layers (C), e.g. SMCS, SMCMS, SCMCS, SSMCS, etc. adhered to a nonwoven fabric according to the present invention. In one embodiment of the present invention a Vistamaxx® resin is adhered to a nonwoven fabric in accordance with the invention.

The present invention also relates to a process for preparing the multi-layer fabric as describe hereinabove.

The first layer may be a pre-formed meltspun layer whereby after or during cooling, the elastic meltspun (spunbond) fibers are collected to form an elastic elastic meltspun fabric. The fabric so obtained can be used as the first layer which will be adhered to the second layer to make the multi-layer fabric according to the invention. However, preferably the fibers of the polyolefin material are adhered to the nonwoven fabric in a partially molten state or partially amorphous state just after they are formed.

Accordingly, the present invention preferably relates to a process for making the present multi-layer fabric, which process comprises the steps of:
(a) providing a plurality of fibers of the polyolefin material which fibers are in a partially molten state or partially amorphous state;
(b) providing the nonwoven fabric; and
(c) adhering the fibers to the nonwoven fabric.

Suitably, in the present process two nonwoven fabrics are provided and the fibers of the polyolefins material are adhered to the two nonwoven fabrics to form the elastic fabric arranged between the two nonwoven fabrics.

The multi-layer fabric according to the present invention as described hereinbefore can very attractively be further processed to obtain a fabric which displays a unique and superior softness. This is most surprising since this would not be expected when use is made of a relatively cheap, stiff and boardy nonwoven fabric as used in accordance with the present invention. The further processing involves the incrementally stretching of the present multi-layer. Such an incrementally stretching process is preferably a ring rolling process. The multi-layer fabric thus obtained displays a unique and superior softness when compared to known multi-layer fabrics including multi-layer fabrics that are based on an elastic layer of fibers or film of a polyolefin material and a spunlaced nonwoven fabric as for instance described in US 2010/0081352. In this respect it is of interest to note that spunlaced nonwoven fabrics are as such softer and more flexible than the preferred carded nonwoven fabrics which are used according to the present invention. Hence, the finding that in accordance with the present invention softer fabrics can be obtained than with a spunlaced nonwoven fabric is indeed highly unexpected.

The present invention therefore also relates to the multi-layer product obtained from such a further processing treatment.

Accordingly, the present invention also relates to the present multi-layer fabric as defined hereinabove which has been subjected to an incrementally stretching process, wherein the stretched fabric obtained has an elongation in the cross machine direction which is at least double the elongation in the cross machine direction of the non-stretched multi-layer fabric, whereby the elongation is measured at a force of 5 Newton.

Such a further processed (“treated”) multi-layer fabric in accordance with the invention comprises an elastic fabric requiring a lower force to initially elongate the elastic nonwoven in the CD direction. Force to elongate is often called modulus. Thus after ring rolling a lower modulus is observed for elongation of the fabric in the CD direction. This reduced modulus shows up as higher elongation at a force of 5 Newton as well as reduced force to elongate to 5% and 10% elongation. Such a lower force to elongate makes the treated fabric higher valued for elastic application where comparable fit is required. Thus use of the fabric in diaper ears would allow the diaper to be smoothly closed without risk of red marking the baby. Such low modulus elastic fabric would also be valued disposable clothing where closing fit could be adjusted without discomfort to the wearer.

Moreover, the treated multi-layer fabric will comprise a nonwoven fabric having a higher elongation in the cross machine direction than the nonwoven fabric in the untreated multi-layer fabric. In addition, the polyolefin staple fibers of the nonwoven fabric in the treated multi-layer fabric will have a higher elongation than the polyolefin staple fibers of the nonwoven fabric in the corresponding non-treated multi-layer fabric. Whilst not wishing to be bound to a particular theory, it is believed that the change in these various properties of the multi-layer fabric results in the unique and superior softness which is now obtained.

Preferably, in such a treated multi-layer fabric the fiber-to-fiber bonds present in the nonwoven fabric have a bond area between 8-20%, preferably between 8-18%, based on the total area of the nonwoven fabric.

In the treated multi-layer fabric according to the present invention the bond area of the nonwoven fabric is preferably 8-20%, more preferably 8-18%, based on total area of the nonwoven fabric.

The present invention also relates to a process for making the treated multi-layer fabric as described hereinabove that has been subjected to an incrementally stretching process.

Accordingly, the present invention also relates to process for making the present a multi-layer fabric, which process comprises the steps of:
(a) providing a first layer which comprises an elastic fabric of fibers of a polyolefin material which elastic fabric has an ultimate elongation of 500%; and a second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(b) adhering the second layer to the first layer to obtain a multi-layer fabric;
(c) subjecting the multi-layer fabric as obtained in step (b) to an incrementally stretching process; and
(d) recovering the stretched multi-layer fabric as obtained in step (c).

Preferably, the present invention relates to a process for making the treated multi-layer fabric, which process comprises the steps of:
(a) providing a plurality of fibers of the polyolefin material which fibers are in a partially molten state or partially amorphous state to form the first layer;
(b) providing the second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(c) adhering the second layer to the fibers of the polyolefin material that form the first layer to obtain a multi-layer fabric;
(d) subjecting the multi-layer fabric as obtained in step (c) to an incrementally stretching process; and
(e) recovering the stretched multi-layer fabric as obtained in step (d).

Further, the present invention relates to a process for making a multi-layer fabric which is comprised of a first layer and a second layer, which process comprises the steps of:
(a) providing the first layer which comprises an elastic fabric of filters of a polyolefin material which elastic fabric has an ultimate elongation of 500%; and the second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(b) adhering the second layer to the first layer to obtain a multi-layer fabric;
(c) subjecting the multi-layer fabric as obtained in step (b) to an incrementally stretching process; and
(d) recovering the stretched multi-layer fabric as obtained in step (c).

The present invention also relates to a process for making a multi-layer fabric which is comprised of a first layer and a second layer comprising the steps of:
(a) providing a plurality of fibers of the polyolefin material which fibers are in a partially molten state or partially amorphous state to form the first layer;
(b) providing the second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(c) adhering the second layer to the fibers of the polyolefin material that form the first layer to obtain a multi-layer fabric;
(d) subjecting the multi-layer fabric as obtained in step (c) to an incrementally stretching process; and
(e) recovering the stretched multi-layer fabric as obtained in step (d).

In addition, the present invention relates to the process wherein in addition a third layer which comprises a nonwoven fabric of bond polyolefin staple fibers as defined hereinbefore is provided, and the fibers of the polyolefin material or the (pre-formed) elastic fabric are adhered to the second and third nonwoven fabrics to form the first layer comprising the elastic fabric arranged between the second and third layer.

The present invention also relates to a multi-layer fabric obtainable by any of the processes according to the invention. Such a multi-layer fabric is unique and superior in terms of softness when compared to known multi-layer nonwoven-based fabrics.

The process for incrementally stretching the multi-layer fabric is preferably a ring rolling process. The ring rolling can suitably performed in the machine direction or the cross machine direction, preferably in the cross machine direction. A ring rolling process can suitably be carried out by means of a so-called activation apparatus. A ring rolling process is a process in which a fabric is supported at closely spaced apart locations and then the unsupported segments of the web between these closely spaced apart locations are stretched. This can be accomplished by passing the web through a nip formed between a pair of meshing corrugated rolls, which have an axis of rotation perpendicular to the direction of web travel. Incremental stretching rolls designed for machine direction and cross direction stretching are for instance described in U.S. Pat. No. 4,223,059.

The activation members of an activation apparatus may include an activation belt and a single activation member wherein the activation belt and single activation member comprise a plurality of teeth and grooves that complement and engage one another at a depth of engagement in a deformation zone. The depth of engagement is capable of increasing linearly over the deformation zone. In exemplary embodiments the deformation zone can be controlled to increase linearly over at least a portion of the deformation zone such that a web interposed between the activation belt and the single activation member in the deformation zone is incrementally stretched at a low rate of strain.

In the ring rolling process the depth of engagement is preferably at least 0.070 inch. More preferably, the depth of engagement is in the range of from 0.100-0.170 inch. The term “depth of engagement” means the extent to which intermeshing teeth and grooves of opposing activation members extend into one another.

Subsequent to the incremental stretching process the multi-layer fabric in accordance with the present invention can suitably continue in the machine direction by means known in the art, including over or around any of various idler rollers, tension-control rollers, and the like, to eventually be recovered.

The multi-layer fabrics according to the present invention can suitably to form, or used as part of, any number of articles, in particular, absorbent articles or hygiene articles.

Accordingly, the present invention also provides an article or an article component comprising the multi-layer fabric according to the present invention.

Preferably, the articles according to the invention comprising the multi-layer constructions are baby diapers, pullups, training pants, hygiene closure systems, adult incontinence briefs and diapers, panty liners, sanitary napkins, medical garments, and bandages. Preferably, the article is a diaper or a training pant. The article component according to the present invention is preferably a diaper ear or a training pant side panel.

The present invention further relates to the use of the multi-layer fabric according to the present invention in absorption and hygiene applications, in particular in diaper or training pant applications.

### Example 1

### According to the Invention

A multi-layer fabric was made using a BIAX-Fiberfilm® meltblown line which was used. This line included an extruder, a die-block and a spinneret, as well as an air manifold for the spinneret. Air pressure was 10 psi and the air temperature was 255° C. to melt the polyolefin material used. The line was operated at a melt pressure of 1800 psi and a melt temperature of 255° C. An array die was used with a spinneret hole density of 75 holes/inch to form a fabric of elastic fibers. As the polyolefin material VistaMaxx® 6202FI was used (ExxonMobil). Spunmelt fibers formed were blown between two Fiberweb High Elongation Carded (HEC) thermobond nonwoven fabrics (FPN332D). The distance between the die and the nonwoven fabrics was maintained at 18 inches. The resulting three layer fabric was pressed together between a smooth press roll and a collector drum and then rolled into a roll. The bond between the layers was sufficient as to not be easily pulled apart. The fabric so obtained comprised an elastic fabric having an ultimate cross direction elongation of 168% at maximum force and 25% elongation at 5 Newtons of force. The layered fabric so obtained was subsequently ring rolled in the cross machine direction whereby the microspanning was completed at 100 feet per minute with a depth engagement of 0.100 inches. The ring rolled fabric so obtained had an ultimate elongation of 182% in the cross direction, and 84% elongation at 5 Newtons of force. The bond between the layers was sufficient as to not be easily pulled apart. The increase from before ring rolling to post ring rolling at the 5 Newton force level is key to the performance. The test method used to obtain the ultimate cross direction elongation percent and the force at 5 Newtons is a sample cut to 1 inch by 8 inches where the 8 inches is in the cross direction, the sample is fashioned between two clamps spaced 5 inches apart and pulled at a rate of 5 inches per minute. The tensile testing device reported the values.

### Example 2

### According to the Invention

A multi-layer fabric was prepared as in Example 1, except that the distance between the meltblown die and the nonwoven fabric was set at 18 inches and the targeted weight of elastic fibers was set at 75 gsm to yield a fabric 10A.

The fabric 10A was then ring rolled as described in Example 1 to produce a second fabric of this invention 10B.

Fabrics 10A and 10B were then tested by cutting stripes of the laminate in the CD and MD direction with dimensions of 1 inch×8 inches, placing said stripes in a tensile testing machine, and operating said tensile testing machine with gage length of 5 inches and cross head speed of 5 inches/minute.

Characterization of 10A (before Ring Rolling) and 10B (after Ring Rolling) follows in Table 1 for the average of three MD and 3 CD stripes for each laminate.

TABLE 1
Test Results

| | 10A | 10B |
|---|---|---|
| | (before Ring Rolling) | (After Ring Rolling) |
| Tensile at Maximum | 53.09 N | 43.18 N |
| Force before Failure MD | | |
| Tensile at Maximum | 11.19 N | 8.89 N |
| Force before Failure CD | | |
| % Elongation at Max | 75.83% | 77.30% |
| Force MD | | |
| % Elongation at Max | 168.84% | 182.38% |
| For | | |
| % Elongation at 5 N | 1.75% | 3.11% |
| Force MD | | |
| % Elongation at 5 N | 24.92% | 84.38% |
| Force CD | | |
| Force at 5% Elongation | 12.53 N | 7.75 N |
| MD | | |
| Force at 5% Elongation | 1.95 N | 0.44 N |
| CD | | |
| Force at 10% Elongation | 17.06 N | 11.35 N |
| MD | | |
| Force at 10% Elongation | 2.73 N | 0.61 N |
| CD | | |

### Example 3

### Comparative Example

A multi-layer fabric as described in Example 1 was made, except that two spunlace nonwoven fabrics were used instead of the Fiberweb High Elongation Carded (HEC) thermobond nonwoven fabrics and that the distance between the meltblown die and the nonwoven fabrics was set at 24 inches. The spunlace nonwoven fabrics were from Jacob Holms Industries, Inc. (50/50 PP/PET, 30 g/m²). It is noted that said spunlace is not only more expensive ($0.15/square meter versus $ 0.11/square meter, but that the spunlace nonwoven fabric feels more soft and less stiff than the nonwoven fabrics used in Example 1.

The multi-layer fabric made in Example 1 displayed most surprisingly a softness which was clearly superior in softness when compared to the softness as obtained with the fabric made in according to Example 3. Hence, the present invention provides a multi-layer fabric having a unique and superior softness when compared with known nonwoven-based multi-layer fabrics, whereas at the same time the production cost is reduced considerably.

1. A multi-layer fabric which is comprised of a first layer and a second layer which are adhered to each other, wherein the first layer comprises an elastic fabric of fibers of a polyolefin material which elastic fabric has an ultimate elongation of at least 500%; wherein the second layer comprises a bonded nonwoven fabric of polyolefin staple fibers in which fiber-to-fiber bonds are present, which nonwoven fabric has an elongation in the cross machine direction of at least 130%, and wherein the polyolefin staple fibers have an elongation of at least 350%.

2. A multi-layer fabric according to claim 1, wherein the fiber-to-fiber bonds present in the nonwoven fabric have a bond area between 8-25%, based on the total area of the nonwoven fabric.

3. A multi-layer fabric according to claim 1 or 2, wherein the fiber-to-fiber bonds are thermal bonds.

4. A multi-layer fabric according to any one of claims 1-3, wherein the nonwoven fabric has an elongation in the cross machine direction of at least 150%, preferably at least 200%.

5. A multi-layer fabric according to any one of claims 1-4, wherein the nonwoven fabric comprises a carded web formed with a processing draft of less than 50% total.

6. A multi-layer fabric according to any one of claims 1-5, wherein the nonwoven fabric has a basis weight of from 20 to 30 grams per square yard, a machine direction tensile strength of at least 1380 grams/inch and a cross machine direction tensile strength of at least 120 grams/inch.

7. A multi-layer fabric according to any one of claims 1-6, wherein the nonwoven fabric has a tensile strength ratio in the machine direction as compared to the cross machine direction of the fabric of 1-10.

8. A multi-layer fabric according to any one of claims 1-7, wherein the polyolefin material has a melt flow rate of at most 90 dg/min.

9. A multi-layer fabric according to claim 8, wherein the polyolefin polymer has a melt flow rate in the range of from 15-50 dg/min.

10. A multi-layer fabric according to any one of claims 1-9, wherein the polyolefin material comprises a propylene-α-olefin copolymer.

11. A multi-layer fabric according to 10, wherein the polyolefin material in addition comprises a propylene homopolymer.

12. A multi-layer fabric according to any one of claims 1-11, wherein the polyolefin material has a molecular weight distribution in the range of from 2-5.

13. A multi-layer fabric according to any one of claims 1-12, wherein the polyolefin material comprises a first component comprising 5-99 wt %, based on the total weight of the polyolefin material, of a polymer selected from the group consisting of homopolymers of propylene and random copolymers of propylene, the polymer having a heat of fusion as determined by DSC of less than 50 J/g and stereoregular propylene crystallinity; and a second component which comprises 1-95 wt %, based on the total weight of the polyolefin material, of a propylene polymer or a blend of propylene polymers; wherein the first and/or the second component has undergone chain scission, and the elastic fabric has a permanent set of less than 60%.

14. A multi-layer fabric according to any one of claims 1-13 comprising in addition a third layer which comprises a nonwoven fabric of bonded polyolefin staple fibers as defined in any one of claims 1-13, wherein the first layer is arranged between the second and the third layer.

15. A process for making a multi-layer fabric according to any one of claims 1-13, comprising the steps of:
(a) providing a plurality of fibers of the polyolefin material which fibers are in a partially molten state or partially amorphous state;
(b) providing the nonwoven fabric; and
(c) adhering the fibers to the nonwoven fabric.

16. A process for making the multi-layer fabric according to claim 15, wherein two nonwoven fabrics are provided and the fibers of the polyolefins material are adhered to the two nonwoven fabrics to form the elastic fabric arranged between the two nonwoven fabrics.

17. A multi-layer fabric as defined in any one of claims 1-15 which has been subjected to an incrementally stretching process, wherein the stretched fabric obtained has an elongation in the cross machine direction which is at least double the elongation in the cross machine direction of the non-stretched multi-layer fabric, whereby the elongation is measured at a force of 5 Newton.

18. A multi-layer fabric according to claim 17, wherein the fiber-to-fiber bonds present in the nonwoven fabric have a bond area between 15-20%, based on the total area of the nonwoven fabric.

19. A multi-layer fabric according to claim 17 or 18 comprising in addition a third layer which comprises a nonwoven fabric of bonded polyolefin staple fibers as defined in any one of claims 1-14, wherein the first layer is arranged between the second and the third layer.

20. A process for making a multi-layer fabric according to claim 17 or 18, comprising the steps of:
(a) providing a first layer which comprises an elastic fabric of fibers of a polyolefin material which elastic fabric has an ultimate elongation of 500%; and a second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(b) adhering the second layer to the first layer to obtain a multi-layer fabric;
(c) subjecting the multi-layer fabric as obtained in step (b) to an incrementally stretching process; and
(d) recovering the stretched multi-layer fabric as obtained in step (c).

21. A process for making a multi-layer fabric according to claim 17 or 18, comprising the steps of:
(a) providing a plurality of fibers of the polyolefin material which fibers are in a partially molten state or partially amorphous state to form the first layer;
(b) providing the second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(c) adhering the second layer to the fibers of the polyolefin material that form the first layer to obtain a multi-layer fabric;
(d) subjecting the multi-layer fabric as obtained in step (c) to an incrementally stretching process; and
(e) recovering the stretched multi-layer fabric as obtained in step (d).

22. A process for making a multi-layer fabric which is comprised of a first layer and a second layer comprising the steps of:
(a) providing the first layer which comprises an elastic fabric of fibers of a polyolefin material which elastic fabric has an ultimate elongation of 500%; and the second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(b) adhering the second layer to the first layer to obtain a multi-layer fabric;
(c) subjecting the multi-layer fabric as obtained in step (b) to an incrementally stretching process; and
(d) recovering the stretched multi-layer fabric as obtained in step (c).

23. A process for making a multi-layer fabric which is comprised of a first layer and a second layer comprising the steps of:
(a) providing a plurality of fibers of the polyolefin material which fibers are in a partially molten state or partially amorphous state to form the first layer;
(b) providing the second layer which comprises a nonwoven fabric of bonded polyolefin staple fibers in which fiber-to-fiber bonds are present, which nonwoven fabric has an elongation in the cross machine direction of at least 130% and the polyolefin staple fibers have an elongation of at least 350%;
(c) adhering the second layer to the fibers of the polyolefin material that form the first layer to obtain a multi-layer fabric;
(d) subjecting the multi-layer fabric as obtained in step (c) to a process for incrementally stretching the multi-layer fabric; and
(e) recovering the stretched multi-layer fabric as obtained in step (d).

24. A process according to any one of claims 20-23, wherein in addition a third layer which comprises a nonwoven fabric of bonded polyolefin staple fibers as defined in any one of claims 1-13 is provided, and the fibers of the polyolefin material or the elastic fabric are adhered to the second and third nonwoven fabrics to form the first layer comprising the elastic fabric arranged between the second and third layer.

25. A process according to any one of claims 20-24, wherein the process for incrementally stretching the multi-layer fabric is a ring rolling process.

26. A process according to claim 25, wherein in the ring rolling process a depth of engagement is applied of at least 0.070 inch.

27. A multi-layer fabric obtainable by the process according to claim 22 or 23.

28. An article or an article component comprising the multi-layer fabric according to any one of claims 1-14, 17 and 18.

29. An article according to claim 28 which is a diaper or a training pant.

30. An article component according to claim 28 which is a diaper ear or a training pant side panel.

31. Use of the multi-layer fabric according to any one of claims 1-14, 17 and 18 in diaper or training pant applications.
